(19) United States
(12) Patent Application Publication
(10) Pub. No.: US 2003/0227923 A1
(43) Pub. Date: Dec. 11, 2003

(54) Method for selecting communication networks

(76) Inventor: Thomas Brumm, Gauting-Konigswiesen (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/440,145

(22) Filed: May 19, 2003

Related U.S. Application Data
(63) Continuation of application No. PCT/DE01/04321, filed on Nov. 16, 2001.

(30) Foreign Application Priority Data
Nov. 17, 2000 (DE) 100 556 944.7

(51) Int. Cl. H04L 12/28

(52) U.S. Cl. 370/395.5; 370/395.2

(57) ABSTRACT

The present invention comprises a method of selecting communication networks by means of dynamically adjustable selection criteria for controlling a link set up between communication terminals. In order to transfer communication, voice and/or data signals from one communication terminal via a communication network chosen from at least two communication networks, one of the said networks being a communication network for the transmission of voice signals, especially a time-division multiplex communication network, and another communication network being a packet-oriented communication network, especially the Internet, the selection of a respective communication network occurs in a network access and selection device connecting the communication terminal concerned to the said communication networks by means of an indication given by the communication terminal concerned according to additionally available information in the network access and selection device and/or information relating to the said communication networks concerned.

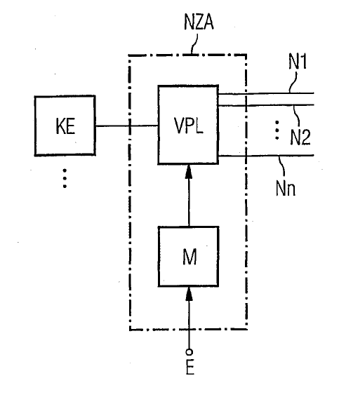

### CROSS-REFERENCE TO RELATED APPLCIATIONS

The present application is a continuation of International Application number PCT/DE01/04321, filed Nov. 16, 2001, and German Application number 100 56 944.7 filed Nov. 17, 2000, both of which are incorporated herein by reference.

### BACKGROUND OF THE INVENTION

The present invention relates to a method for selecting communication networks. The method operates according to dynamically adjustable selection criteria for controlling a link set up between communication terminals. This is performed in order to transfer communication, voice, and data signals, via a communication network chosen from at least two communication networks wherein one of the networks is a communication network provided for the transmission of voice signals, such as a time-division multiplex communication network and another communication network being a packet-oriented communication network, such as the Internet. The selection of the respective communication network is controllable in a network access and selection device connecting the communication terminal concerned to the mentioned communication networks according to an indication provided by the relevant communication terminal.

The transmission of data packets via either a packet-switching network such as the Internet or at least one alternative network including a time-division multiplex communication network, is known from U.S. Pat. No. 5,732,078. In order to reroute data packets, normally transmitted via the packet-switching network, to at least one of the available alternative networks, provision is made to initially set up a test link between the access node to which one communication terminal transmitting the relevant data packets is connected and a destination node, in the course of which a check is performed to determine whether the bandwidth required for the data packets to be transmitted can in fact be provided. If the required available access node bandwidth cannot be provided in the destination node, a possible bandwidth is negotiated between the aforementioned nodes. Following such a test connection, in order to be able to transmit data packets via an alternative network providing the required bandwidth, there is provided according to the prior art a means to modify an existing routing table in such a way that in addition to the respective destination addresses of the nodes to which the data packets are to be forwarded, the table also contains at least the original addresses of the data packets to be rerouted on account of a quality required by the user and, if necessary, also an application port number.

Per the above patent, after a test link is set up between source and destination nodes, a modification of a routing table occurs, on a case-by-case basis, that is to some extent an individual transmission of data packets with an assured bandwidth. This method is rather complicated because a separate link must be set up for each transmission of data packets with a required bandwidth that is initiated by a user, and in fact via the alternative network, and that the aforementioned routing table has to be modified in each access node after each transmission of data packets with a specific bandwidth that is initiated by a user.

Per reference WO 00/08798, a method for rerouting data packets that are to be transmitted via a packet-switching network, especially the Internet, to at least one alternative network, especially a time-division multiplex network, is known. The method ensures the required quality of service for these data packets. The packet-switching network and the at least one alternative network, in this case form subnetworks of a communication network. The subnetworks comprise at least one source node and one destination node, each of which is connected directly or indirectly via at least one transit node to an access node that can set up a link both to the packet-switching network and an alternative network, and between which data packets can be transmitted. With this known method, for the purpose of rerouting the data packets through an alternative network ensuring the required quality of service for these data packets, the relevant data packet is merely identified in each case by a bit pattern for such a rerouting. The pattern is known to the access node linked directly or indirectly to the source node via at least one transit node. When a data packet, identified by the respective bit pattern, arrives in the access node, a rerouting of a data packet identified by the relevant bit pattern to an alternative network takes place solely owing to the recognition of the relevant bit pattern. Therefore, in contrast to the above cited prior art method, with the second method now being considered, only a one-time identification by a known bit pattern of the data packet to be transmitted is required to effect the transmission of the relevant data packet via an alternative network. This identification usually takes place in the communication terminal from which the data packets are transmitted.

It is now apparent that, with regard to the transmission via an alternative network of data packets normally transmitted via a packet-oriented network, these known measures under consideration are sometimes not adequate to take into account in the best manner the different conditions in the network and/or the type of signals. Per U.S. Pat. No. 5,732,078, the respective connection path is determined on the basis of conditions at the reception end. Per WO 00/08798, the particular connection path is determined on the basis of administratively specified codes provided at the transmission end.

### BRIEF SUMMARY OF THE INVENTION

An advantage of the present invention is to provide a straightforward method whereby not only the requirements from the respective communication terminal, with regard to the use of a communication network, can be considered but moreover the information affecting the individually available communication networks and/or the information regarding the particular signals to be transmitted can also be considered in an optimal manner.

These and other advantages may be achieved by the present inventive method wherein indication in the network access and selection device is assessed according to additional information contained in the network and/or according to information relevant to the communication networks, and the communication network for the actual transmission of the respective signals is selected by the network access and selection device from the existing communication networks on the basis of the result of this assessment.

The present invention also comprises a method for selecting a communication network from at least two communication networks by means of dynamically adjustable selection criteria for controlling a link set up between communication terminals, comprising the steps of: forming a connection with a first of said at least two communication network comprising a time-division multiplex communication network and a second communication network comprising a packet-oriented communication network; transmitting an indication that designates only a communication network preferred for use from a communication terminal to a network access and selection device connecting said communication terminal with said at least two communication networks; selecting a communication network from within said network access and selection device using an indication criterion according to additional information present in said network access and selection device and/or according to information affecting one of the communication networks; and using another indication criterion supplied by said communication terminal for performing said step of selecting.

An additional advantage of the present invention is that not only the indication supplied by the communicating terminal in each case, regarding the communication network to be used for the transmission of signals, is taken into account but, moreover, in a more or less two-dimensional manner, the additional information regarding the network access present in, or available to, the network access and selection device is also taken into account in an optimal manner.

A still further advantage of the present invention as compared with the U.S. Pat. No. 5,732,078 method is that in principle no data from the reception end is required for a network selection. Further, with respect to the WO 00/08798 method, the invention has the advantage that no fixed routing control is necessary, but instead a dynamically adjustable network selection and hence routing control is used.

The indication in the network access and selection device can thus be assigned to the communication terminal connected or it can be signaled to it by the relevant communication terminal. Furthermore, the indication can be implicitly derived from the service criteria when setting up a link, the derivation being made with an administrable table in the associated network access and selection device establishing the assignment between service and the preferred network. Furthermore, the indication can be determined from separate criteria containing information regarding the connected networks, such as network loading, costs, or prioritizing of a network. Adjustable prioritizing enables an indication to be determined from the assembled information. In this way, the determination can be created by a logic operation combining individual indications.

Thus, according to a suitable embodiment of the invention, the communication network preferred for the transmission of signals is designated purely on the basis of the indication output by the communication terminal, and the communication network actually selected for the transmission of the relevant signals is determined by the network access and selection device according to the service criteria for the particular type of signals. Accordingly, the assignment between the particular service and preferred communication network can be provided in an administrable table in the network access and selection device. Thus, for example, facsimile data sent by the relevant communication terminal can be transmitted according to the appropriate service criteria via a packet-switching network, such as the Internet, even though a time-division multiplex communication network, for example, has been specified by the relevant communication terminal as the preferred network.

It is preferable in this case that the communication network preferred for the transmission of the relevant signals be designated by the indication output for the relevant communication terminal, and that the communication network actually chosen for the transmission of the relevant signals is determined by the access and selection device according to this criterion.

It is preferable in this case that the indication given for the relevant communication terminal only designates the communication network preferred for transmission of the relevant signals, and that the communication network actually chosen for the transmission of the relevant signals is determined by the network access and selection device according to an indication supplied by the communication terminal. This measure can especially be made use of in that no separate overhead has to be provided in the network access and selection device for the storage of separate criteria to be taken into account.

It is further advantageous if in the case where the indication given for the communication terminal designates only the communication network preferred for use for transmission of the relevant signals, and that the communication network actually chosen by the network access and selection device for the transmission of the relevant signals is determined in accordance with a separate criterion formed in the network access and selection device. To create a criterion of this kind, the relevant communication terminal can, in addition to the indication it has already supplied, additionally consider information already provided and/or information made available by the operators of the various networks, e.g. regarding network availability.

It is still further advantageous to use a loading of the communication networks that can be selected for the network access and selection device and/or the costs for the use of the relevant networks as separate criteria. This enables a particularly optimum utilization to be achieved for the relevant signals to be transmitted.

It is also advantageous to use a prioritization of the use of available communication networks for the transmission of the respective signals as a separate criterion in the network access and selection device.

To assess the various indications or, as the case may be, the indications derived from the separate criteria, it is possible to prioritize the various indications and thus to determine, by using a logic operation, the indication to be implemented. It is thus, for example, possible to prioritize the transmission of a voice service or voice signals via a voice network and to select a packet network in the event of an overload condition of the voice network. This enables particularly optimum utilization of the available communication networks using different criteria.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawings, wherein:

the FIGURE depicts a block diagram of a network access and selection device as a connecting device between a communication terminal and various communication networks.

### DETAILED DESCRIPTION OF THE INVENTION

The FIGURE depicts a communication terminal KE of a communication system, comprising a number of corresponding communication terminal installations. A communication terminal installation may contain one or more terminal devices, such as a digital or analogue telephone set, a facsimile or fax machine, a data transmission device, a personal computer, a video device, etc. The communication terminal KE shown in the drawing is connected to a network access and selection device NZA that in turn is connected to a series of communication networks N1, N2 and Nn. At least one communication network, e.g. N1, is a communication network provided for the transmission of voice signals. N1 may be a time-division multiplex communication network such as the switching system EWSD which when used in practice is formed by these communication networks N1, N2 to Nn. At least one other communication network of the relevant communication networks N1, N2 to Nn, for example communication network N2, is formed by a packet-oriented communication network such as the Internet. In principle, signals can be transmitted from and to all communication installations, such as communication terminal KE, through all communication networks N1, N2 to Nn, that can be accessed by the network access and selection device NZA and selected for the relevant signal transmission. This means that voice signals can be transmitted not only via the communication network N1 provided for the transmission of voice signals, but also completely via the packet-oriented communication network N2. Conversely, data signals, such as those supplied by facsimile machines, can be transmitted not only via the packet-oriented communication network N2 but also via the communication network N1, otherwise provided for the transmission of voice signals. The NZA is operated with selectable criteria including costs for utilization and/or loading of networks.

For the selection, from communication networks N1, N2 to Nn, of the communication network to be used for the transmission of a particular signal, a first indication to the network access and selection device NZA is initially administered. This indication usually designates the communication network preferred for use for the transmission of the respective signals. The relevant indication is applied in the network access and selection device NZA to a priority and logic element VPL. The input end of the logic device is connected to the output end of a memory M to which further information for storage can be applied at a separate input terminal E. These particular indications represent additional information that is therefore present in the network access and selection device NZA and/or is thus used in the priority and logic element VPL to assess the information supplied by the relevant communication terminal KE for the choice, from communication networks N1, N2 to Nn, of the communication network to be used to transmit the relevant signals. Thus, the information provided by the respective communication terminal installation, such as the communication terminal KE, concerning the particular communication network to be used, or preferred for use, and the separate information regarding the communication network to be chosen, present in the network access and selection device NZA or derived or formed from there from additional information supplied, is processed in a two-dimensional manner, so to speak, in order to choose the communication network to be actually used for the transmission of the relevant signals on the basis of this result.

The information provided by the relevant communication terminal concerning the communication network preferred for use for transmission of the relevant signals can thus take account of a separate criterion contained in the mentioned memory M, that, for example, takes account of the availability or utilization of the communication networks that can be selected by the network access and selection device NZA and/or the costs for the utilization of the relevant communication networks. In addition to, or instead of, this information, separate criteria provided from the relevant communication terminal KE for the selection of the particular communication network to be utilized can also be used, such as a service criterion that provides information on the type of the particular signal to be transmitted, or other supplied separate criteria, such as a quality requirement for the particular signal transmission.

Furthermore, it is also possible by means of the priority and logic element VPL of the network access and selection device NZA to prioritize the utilization of the communication networks N1, N2 to Nn available for the transmission of the relevant signals. Various criteria from the aforementioned criteria can thus be used for determining the priority.

By means of the aforementioned measures, the optimum use of the communication networks available for the transmission of signals can be achieved to meet the various requirements and wishes of the particular communication terminal, while at the same time allowing for the particular conditions of the communication networks and/or network operators.

Choosing a network using the described information may require suitable network interworking. In the arrangement shown in the drawing, this network interworking is controlled or specified from the transmission end by the network work access and selection device NZA. If the signal transport takes place via a different physical network than the network in which the receiver, i.e. the communication installation at the reception end, is located, a network interworking must take place in the network of the relevant receiver. Therefore, a connection, by means of which a packet network is to be used and that wants to reach a destination subscriber in the voice network, must be established via network interworking or a network interworking device in the voice network.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A method for selecting a communication network from at least two communication networks by means of dynamically adjustable selection criteria for controlling a link set up between communication terminals, comprising the steps of:
forming a connection with a first of said at least two communication network comprising a time-division multiplex communication network and a second communication network comprising a packet-oriented communication network;
transmitting an indication that designates only a communication network preferred for use from a communication terminal to a network access and selection device connecting said communication terminal with said at least two communication networks;
selecting a communication network from within said network access and selection device using an indication criterion according to additional information present in said network access and selection device and/or according to information affecting one of the communication networks; and
using another indication criterion supplied by said communication terminal for performing said step of selecting.

2. The method according to claim 1, wherein criterion relating to signal type transmitted by said communication terminal is used for the selection.

3. The method according to claim 1, wherein a chosen communication network is determined in accordance with separate criteria present and formed via said network access and selection device.

4. The method according to claim 3, wherein a loading of said communication networks and costs for utilization of said communication networks are used as separate criteria.

5. The method according to claim 3, further comprising the step of prioritizing utilization of said communication networks via said network access and selection device.

6. The method according to claim 4, further comprising the step of prioritizing utilization of said communication networks via said network access and selection device.

7. The method according to claim 3, wherein a loading of said communication networks or costs for utilization of said communication networks are used as separate criteria.

8. The method according to claim 7, further comprising the step of prioritizing utilization of said communication networks via said network access and selection device.

9. The method according to claim 1, wherein a chosen communication network is determined in accordance with separate criteria present or formed via said network access and selection device.

10. The method according to claim 9, wherein a loading of said communication networks and costs for utilization of said communication networks are used as separate criteria.

11. The method according to clam 9, further comprising the step of prioritizing utilization of said communication networks via said network access and selection device.

12. The method according to claim 10, further comprising the step of prioritizing utilization of said communication networks via said network access and selection device.

13. The method according to claim 9, wherein a loading of said communication networks or costs for utilization of said communication networks are used as separate criteria.

14. The method according to claim 13, further comprising the step of prioritizing utilization of said communication networks via said network access and selection device.

15. A method for selecting a communication network from at least two communication networks by means of dynamically adjustable selection criteria for controlling a link set up between communication terminals, comprising the steps of:
forming a connection with a first of said at least two communication network comprising a time-division multiplex communication network and a second communication network comprising a packet-oriented communication network;
transmitting an indication that designates only a communication network preferred for use from a communication terminal to a network access and selection device connecting said communication terminal with said at least two communication networks;
selecting a communication network from within said network access and selection device using an indication criterion according to additional information present in said network access and selection device or according to information affecting one of the communication networks; and
using another indication criterion supplied by said communication terminal for performing said step of selecting.

16. The method according to claim 15, wherein criterion relating to signal type transmitted by said communication terminal is used for the selection.

17. The method according to claim 15, wherein a chosen communication network is determined in accordance with separate criteria present and formed via said network access and selection device.

18. The method according to claim 17, wherein a loading of said communication networks and costs for utilization of said communication networks are used as separate criteria.

19. The method according to claim 17, further comprising the step of prioritizing utilization of said communication networks via said network access and selection device.

20. The method according to claim 18, further comprising the step of prioritizing utilization of said communication networks via said network access and selection device.

21. The method according to claim 17, wherein a loading of said communication networks or costs for utilization of said communication network are used as separate criteria.

22. The method according to claim 21, further comprising the step of prioritizing utilization of said communication networks via said network access and selection device.
